(19) United States
(12) Patent Application Publication
(10) Pub. No.: US 2025/0178567 A1
(43) Pub. Date: Jun. 5, 2025

(54) SENSOR CLEANING SYSTEM

(71) Applicants: HYUNDAI MOTOR COMPANY, Seoul (KR); KIA CORPORATION, Seoul (KR)

(72) Inventors: Seung Hyun Lee, Incheon (KR); Yoon Geun Cho, Daegu (KR); Hae Jun Jeong, Siheung-si (KR)

(73) Assignees: HYUNDAI MOTOR COMPANY, Seoul (KR); KIA CORPORATION, Seoul (KR)

(21) Appl. No.: 18/676,596

(22) Filed: May 29, 2024

(30) Foreign Application Priority Data
Dec. 5, 2023 (KR) 10-2023-0173893

(51) Int. Cl. B60S 1/56; B60R 16/08

(52) U.S. Cl. CPC B60S 1/56; B60R 16/08

(57) ABSTRACT

A sensor cleaning device for a vehicle includes a housing mounted to an environment sensor of the vehicle. A compressed fluid may be selectively supplied into the housing. A rotor may be disposed in the housing and rotatable with respect to the environment sensor by the compressed fluid.

### CROSS-REFERENCE TO RELATED APPLICATION

This application claims, under 35 U.S.C. § 119 (a), the benefit of and priority to Korean Patent Application No. 10-2023-0173893, filed on Dec. 5, 2023, the entire contents of which are incorporated herein by reference.

### TECHNICAL FIELD

The present disclosure relates to cleaning of a sensor. More particularly, it relates to a sensor cleaning system for an environment sensor of a vehicle.

### BACKGROUND

Recently, driver assistance systems for assisting drivers of vehicles are applied to the vehicles to ensure safe driving in various traveling situations. In addition to the driver assistance systems, research and development has been further actively conducted on autonomous vehicles to autonomously travel without a driver's intervention.

The driver assistance system or the autonomous vehicle is equipped with various types of environment sensors that may detect environments around the vehicle in various ways. Examples of the environment sensors mounted to the vehicle may include a radar, a LiDAR, a camera, and the like.

Because these sensors are mounted on the external side of the vehicle, the sensing parts thereof may be easily contaminated by rainwater, snow, foreign substances, such as dust, and the like. Because the sensors need to be kept clean at a certain level or higher to ensure sensor performance, sensor cleaning systems are mounted in the vehicles to clean the sensors when the sensing parts are contaminated.

The above information disclosed in this Background section is provided only to enhance understanding of the background of the present disclosure, and therefore it may contain information that does not form the prior art that is already known to a person of ordinary skill in the art.

### SUMMARY

The present disclosure has been made in an effort to solve the above-described problems associated with the prior art, and an object of the present disclosure is to provide a sensor cleaning device and system capable of effectively protecting environment sensors of a vehicle and providing an excellent cleaning performance.

Another object of the present disclosure is to provide a vehicle including the sensor cleaning device and system.

The object of the present disclosure is not limited to the foregoing, and other objects not mentioned herein should be clearly understood by those of ordinary skill in the art to which the present disclosure pertains (hereinafter, “those skilled in the art”) based on the description below.

The features of the present disclosure to achieve the object of the present disclosure as described above and perform the characteristic functions of the present disclosure to be described later are as follows.

In one aspect of the present disclosure, a sensor cleaning device includes a housing mounted to an environment sensor, and a compressed fluid is selectively supplied into the housing. The sensor cleaning device further includes a rotor rotatable with respect to the environment sensor by the compressed fluid and disposed in the housing.

In another aspect of the present disclosure, a sensor cleaning system includes: a valve configured to supply compressed air and be openable: a sensor cleaning device configured to be in fluid communication with the valve; and a controller configured to control the operation of the valve.

In still another aspect of the present disclosure, a method includes: detecting, by a controller, contamination on an environment sensor of a vehicle: opening, by the controller, a valve capable of supplying compressed air in response to determining that the environment sensor is contaminated; and rotating the sensor cleaning device using the compressed air supplied to the sensor cleaning device. Here, the sensor cleaning device may be mounted to the environment sensor and configured to be in fluid communication with the valve.

Other aspects and embodiments of the present disclosure are discussed below.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 is a block diagram illustrating a sensor cleaning system according to an embodiment of the present disclosure:

FIG. 2 is a view illustrating an exemplary vehicle:

FIG. 3 is a perspective view of a sensor cleaning device according to an embodiment of the present disclosure;

FIG. 4 is an exploded perspective view of FIG. 3;

FIG. 5 is a perspective view illustrating a portion of a sensor cleaning device according to an embodiment of the present disclosure:

FIG. 6 is a view illustrating a rotor and a bearing of a sensor cleaning device according to an embodiment of the present disclosure;

FIG. 7 is a cross-sectional view of a sensor cleaning device according to an embodiment of the present disclosure in which a rotor and a bearing are coupled to each other, taken along line L1-L1 of FIG. 4;

FIG. 8 is a view illustrating an environment sensor for a sensor cleaning device according to an embodiment of the present disclosure:

FIG. 9 is a cross-sectional view of an environment sensor to which a sensor cleaning device according to an embodiment of the present disclosure is mounted, taken along line L1-L1 of FIG. 4:

FIG. 10 is a perspective view illustrating a state before an outer housing of the sensor cleaning device, according to an embodiment of the present disclosure, is coupled to an environment sensor:

FIG. 11 are views illustrating an assembly process of a sensor cleaning device according to an embodiment of the present disclosure;

FIG. 12 is an assembly flowchart for a sensor cleaning device according to an embodiment of the present disclosure:

FIG. 13 is a control flowchart for a sensor cleaning system according to an embodiment of the present disclosure:

FIG. 14 is a perspective view of a sensor cleaning device according to an embodiment of the present disclosure; and

FIG. 15 is a cross-sectional view of a sensor cleaning device according to an embodiment of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, should be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It should be understood that, when a component is referred to as being “connected to” or “brought into contact with” another component, the component may be directly connected to or brought into contact with the other component, or intervening components may also be present. In contrast, when a component is referred to as being “directly connected to” or “directly brought into contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements. When a component, device, element, or the like of the present disclosure is described as having a purpose or performing an operation, function, or the like, the component, device, or element should be considered herein as being “configured to” meet that purpose or to perform that operation or function.

Hereinafter, the present disclosure is described in detail with reference to the accompanying drawings.

As described above, sensor surfaces of environment sensors for detecting environments around a vehicle need to be periodically cleaned to maintain the performance of the environment sensors. For example, environment sensors may be contaminated by solids, such as dust and sand, and may be stained by liquids, such as raindrops during precipitation and snow.

Particularly, in an active autonomous vehicle, the vehicle travels based on information on the surrounding environment, such as traffic lights, pedestrians, road types, buildings, and surrounding vehicles, recognized by environment sensors. When the surface of the environment sensor is contaminated, the environment sensor is unable to recognize the surrounding environment, and thus active autonomous traveling is impossible. For this reason, a sensor cleaning system of a vehicle plays an important role of enabling autonomous traveling by helping the environment sensor to clearly recognize the surrounding environment and removing contaminants from the surface of the sensor.

The environment sensor may be cleaned using a washer fluid or high-pressure air. When the washer fluid is used to clean the sensor, moisture on the sensor may be removed by spraying air on the sensor. When using the high-pressure air, only high-pressure air is used to remove foreign substances from the sensor surface. Additionally, there may be a cleaning method that uses a combination of a washer fluid and high-pressure air.

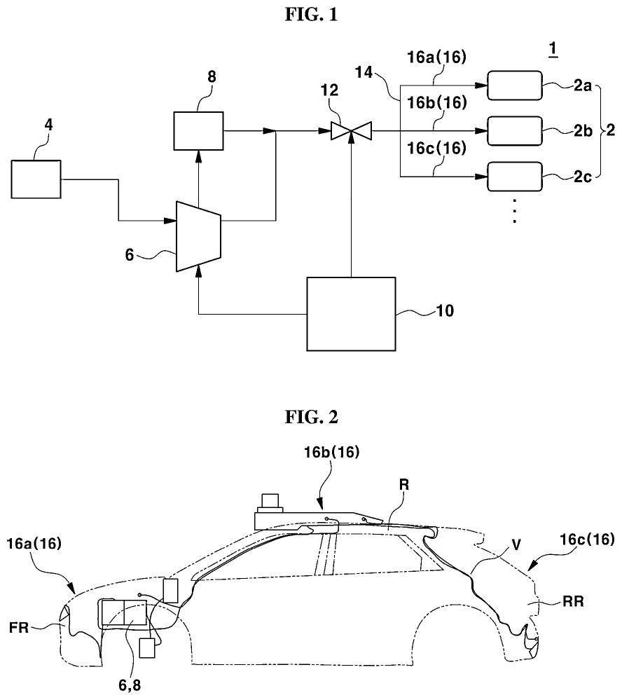

As illustrated in FIGS. 1 to 2, a sensor cleaning system 1 according to an embodiment of the present disclosure may clean an environment sensor 2 using a compressed fluid or compressed air. Generally, in an air cleaning system, compressed air is sprayed onto the environment sensor 2. The environment sensor 2 is cleaned by the compressed air sprayed thereon. However, the sensor cleaning system 1 of the present disclosure includes a sensor cleaning device 100 and performs indirect cleaning using compressed air, instead of using a method of directly spraying compressed air onto the surface of the environment sensor 2.

The environment sensor 2 may be installed in a vehicle equipped with a driver assistance system, an autonomous vehicle, and the like, in order to detect surrounding environment of the vehicle “V”. As a non-limiting example, the environment sensor 2 includes a sensing device, such as a LiDar, a radar, and a camera. The environment sensor 2 may be disposed at least one of the front side “FR”, the rear side “RR”, both sides, or the roof “R” of the vehicle V. The environment sensor 2 includes a plurality of environment sensors 2a, 2b, 2c. Although there are described three environment sensors in this specification and drawings, the number of the environment sensors is not limited thereto and may be increased or decreased.

Air is filtered by an air filter 4 provided in the vehicle V and is introduced into a compressor 6. The compressor 6 is configured to generate compressed air. The air compressed by the compressor 6 or air supplied from an external device may fill in an air tank 8. The air filling the air tank 8 may be used for cleaning the environment sensor 2.

The sensor cleaning system 1 includes a controller 10 configured to operate a valve 12 (e.g., a solenoid valve) for each preset period or in a preset situation, such as when the environment sensor 2 detects contamination. Therefore, the compressed air may be supplied from the compressor 6 or the air tank 8 to the respective environment sensors 2 through a hose 16. The compressed air supplied to the environment sensors 2 may be used for cleaning of the environment sensors 2 by the sensor cleaning device 100. The valve 12 is provided with or integrated with a distributor 14 to distribute the compressed air to each of the environment sensors (2a, 2b, 2c) via hoses 16a, 16b, 16c (collectively, the hose 16). FIG. 2 illustrates the hoses 16a, 16b, 16c corresponding to the plurality of environment sensors 2a, 2b and 2c (collectively, the environment sensor 2).

Because the environment sensor 2 is exposed outside the vehicle V, when the vehicle V is traveling, the environment sensor 2 or a sensing portion 32 of the environment sensor 2 may be damaged by an object, such as a stone flying toward the vehicle V. Moreover, when using a method of directly spraying a fluid through a nozzle installed in the environment sensor 2, a fluid discharge port in the nozzle is exposed outside and thus may be clogged by foreign substances, such as mud.

To address such issues, the present disclosure provides a sensor cleaning device capable of effectively protecting the environment sensor of the vehicle and providing an excellent cleaning performance, and a sensor cleaning system including the same.

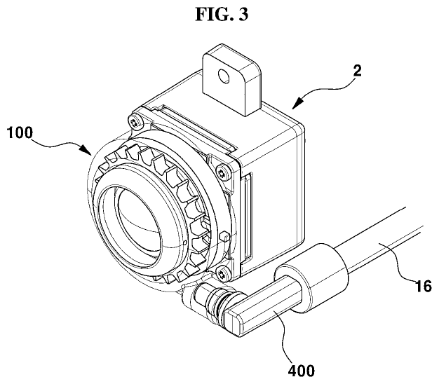

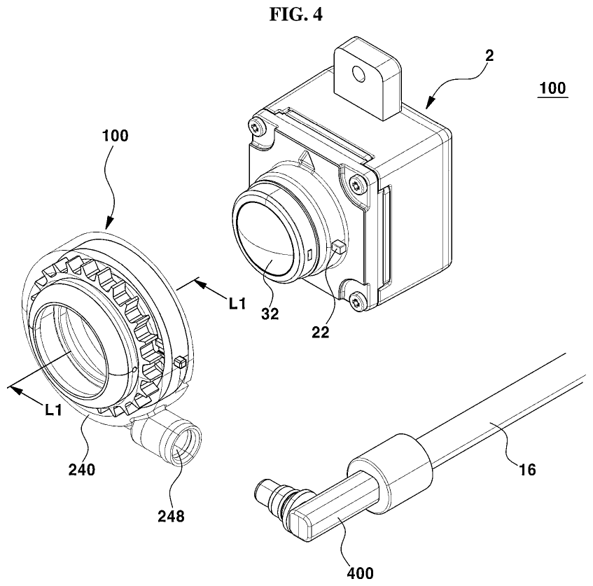

Referring to FIGS. 3 to 4, the sensor cleaning device 100 according to the present disclosure is mounted to the environment sensor 2. The sensor cleaning device 100 is operated by the compressed air supplied from the compressor 6 of the sensor cleaning system 1 to clean the environment sensor 2.

According to an implementation of the present disclosure, the sensor cleaning device 100 includes a housing (220, 240) and a rotor 300. The housing may include an inner housing 220 and an outer housing 240.

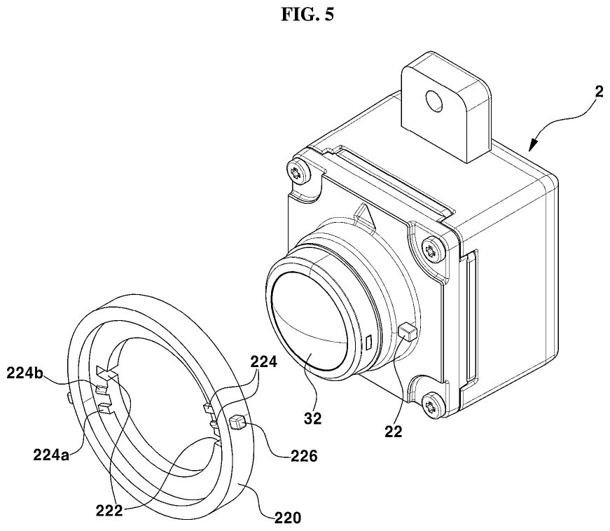

Referring to FIG. 5, the inner housing 220 may be fixed to the environment sensor 2. In one implementation, the environment sensor 2 includes a rib 22. The inner housing 220 includes a groove 222 and a fixation protrusion 224 configured to work in conjunction with the rib 22.

The rib 22 protrudes from the environment sensor 2. In one implementation, the environment sensor 2 may be provided with one rib 22. According to one implementation, the environment sensor 2 may be provided with two or more ribs 22.

In one implementation, the inner housing 220 may have a ring shape. The groove 222, which is recessed radially outward of the inner housing 220, may be formed in the inner circumferential surface of the inner housing 220. The groove 222 allows the rib 22 to be inserted thereinto.

The fixation protrusion 224 of the inner housing 220 is disposed adjacent to the groove 222 in the inner housing 220. The fixation protrusion 224 may protrude in the axial direction of the inner housing 220. In one implementation, two or more fixation protrusions 224 may be formed on the inner housing 220. The fixation protrusions 224 may include a first fixation protrusion 224b and a second fixation protrusion 224a. In one embodiment, the second fixation protrusion 224a may have an axial height greater than the axial height of the first fixation protrusion 224b. As is described in detail below, the inner housing 220 is rotationally coupled to the environment sensor 2. After the inner housing 220 is coupled to the environment sensor 2, the second fixation protrusion 224a may block additional movement of the inner housing 220. The first fixation protrusion 224b may ensure firm fixation between the inner housing 220 and the environment sensor 2 while enabling easy attachment and detachment therebetween.

In one implementation, the groove 222 may be provided in the same number as the ribs 22. For example, when two ribs 22 are formed on the environment sensor 2 as in the illustrated implementation, the inner housing 220 may include two grooves 222. For each rib 22, one or more fixation protrusions 224 may be provided.

An assembly protrusion 26 is arranged in the outer circumferential surface of the inner housing 220. The assembly protrusion 226 protrudes radially outward from the inner housing 220. The assembly protrusion 226 may facilitate coupling between the inner housing 220 and the outer housing 240 and strengthen the coupling therebetween.

The rotor 300 is mounted to the environment sensor 2. Specifically, the rotor 300 may be disposed on the environment sensor 2 to surround the sensing portion 32 of the environment sensor 2. In one implementation, the rotor 300 includes a lens 320. The lens 320 may be made of a transparent material and may be made of a material that does not affect the detection performance of the environment sensor 2.

Particularly, the rotor 300 is rotatably coupled to the environment sensor 2. The rotor 300 may rotate by pneumatic pressure. To this end, in one implementation, a bearing 500 is coupled to the rotor 300. In one example, the bearing 500 may be a sealed bearing.

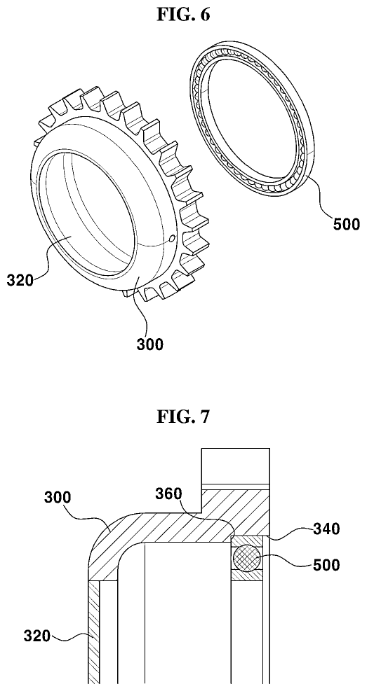

As illustrated in FIGS. 6 and 7, the bearing 500 is coupled to the rotor 300. In one implementation, the bearing 500 may be press-fitted to the rotor 300. The sensor cleaning device 100 may include a structure designed for stable coupling between the rotor 300 and the bearing 500. In one implementation, the structure may be a stepped structure.

As clearly illustrated in FIG. 7, a radially extended portion 340 is formed in the inner circumferential surface of the rotor 300. The radially extended portion 340 has a diameter greater than that of the inner circumferential surface of the rotor 300. The radially extended portion 340 may form a wall 360 in the inner circumferential surface of the rotor 300. The bearing 500 is mounted on the wall 360. The wall 360 allows the bearing 500 to be fixed in a predetermined position and may prevent the bearing 500 from further moving toward the rotor 300.

In one implementation, the bearing 500 may have a ring shape. The outer circumferential side of the bearing 500 is fixed on the wall 360, restricting the same from moving. The inner circumferential surface of the bearing 500 may be fixed by the environment sensor 2.

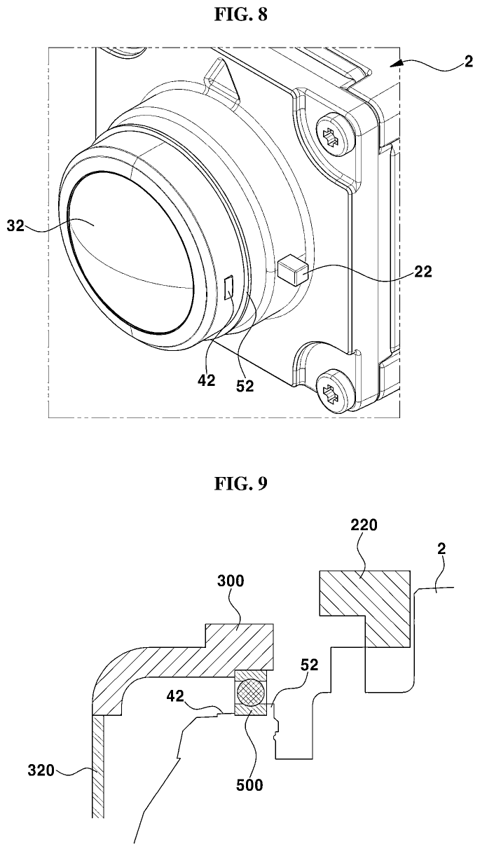

As illustrated in FIGS. 8 and 9, in one implementation, the environment sensor 2 may have a first retaining protrusion 42 and a second retaining protrusion 52 formed thereon. The first retaining protrusion 42 is disposed upstream in a direction in which the rotor 300 and the bearing 500 are coupled to the environment sensor 2. The second retaining protrusion 52 is disposed downstream in the direction in which the rotor 300 and the bearing 500 are coupled to the environment sensor 2. In other words, the second retaining protrusion 52 is disposed closer to the central portion of the environment sensor 2 than the first retaining protrusion 42.

The first retaining protrusion 42 and the second retaining protrusion 52 protrude radially outward of the environment sensor 2. In one example, the protruding height of the first retaining protrusion 42 may be smaller than the protruding height of the second retaining protrusion 52. With this structure, the second retaining protrusion 52 may prevent the bearing 500 from moving toward the central portion of the environment sensor 2. Also, the first retaining protrusion 42 having a smaller protruding height may facilitate assembly and disassembly when attaching or detaching the rotor 300 and the bearing 500 to or from the environment sensor 2.

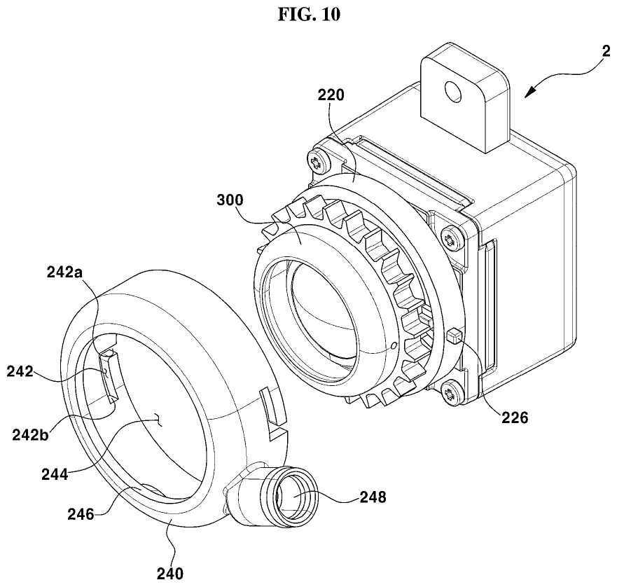

As illustrated in FIG. 10, the outer housing 240 may be coupled to the environment sensor 2 while surrounding the inner housing 220 and the rotor 300. In one implementation, the outer housing 240 may include a coupling portion 242. The coupling portion 242 may be operatively associated with the assembly protrusion 226 of the inner housing 220 to ensure firm coupling between the outer housing 240 and the inner housing 220.

In one implementation, the coupling portion 242 includes an entrance 242a and a seating portion 242b. The entrance 242a and the seating portion 242b may be formed to be substantially perpendicular to each other in the outer housing 240. The coupling portion 242 extends from the entrance 242a in the axial direction of the outer housing 240 and then extends in the circumferential direction of the outer housing 240. The seating portion 242b is disposed at a position spaced apart from the entrance 242a in the circumferential direction of the outer housing 240. After the assembly protrusion 226 is inserted into the entrance 242a, the outer housing 240 is rotated to seat the assembly protrusion 226 in the seating portion 242b.

The outer housing 240 includes an opening 244. The opening 244 overlaps the sensing portion 32 and the lens 320 of the rotor 300.

According to one implementation of the present disclosure, the outer housing 240 includes a hole 246. The hole 246 may circulate air introduced into the sensor cleaning device 100.

The hose 16 may be connected to the outer housing 240. Through the hose 16, compressed air may be supplied to the sensor cleaning device 100. In one implementation, the outer housing 240 has a connecting portion 248 configured to connect the hose 16 to the outer housing 240. In one example, in order to facilitate coupling between the hose 16 and the connecting portion 248, a connector 400 may be disposed between the hose 16 and the connecting portion 248 to interconnect the hose 16 and the connecting portion 24 to each other.

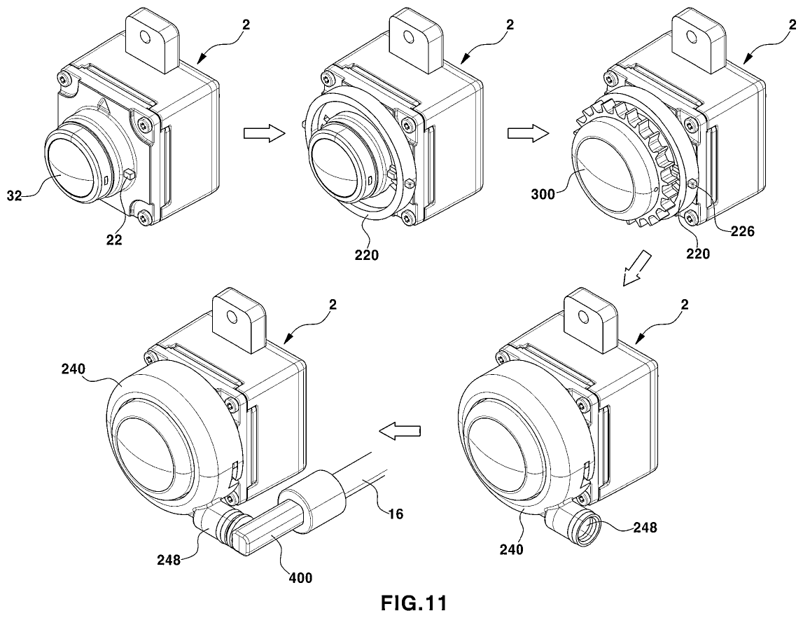

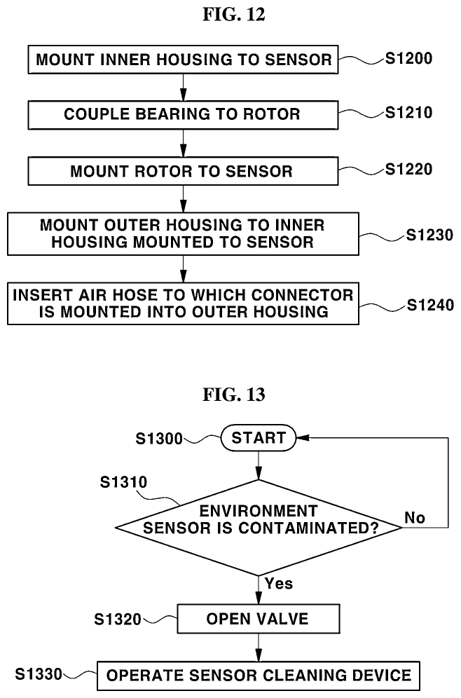

FIGS. 11 to 12 show the assembly process of the sensor cleaning device 100.

The inner housing 220 is mounted to the environment sensor 2 at step S1200. The groove 222 in the inner housing 220 is aligned with the rib 22 of the environment sensor 2, and the inner housing 220 is coupled to the environment sensor 2. When the inner housing 220 is rotated in a first direction (e.g., clockwise), the fixation protrusion 224 is placed rearwards of the assembly protrusion 226 and the inner housing 220 is mounted to the environment sensor 2. The inner housing 220 is fixed using the first fixation protrusion 224b, and the rotation of the inner housing 220 may be blocked using the second fixation protrusion 224a. The first fixation protrusion 224b has a protruding height smaller than that of the second fixation protrusion 224a, facilitating attachment and detachment. Here, because the second fixation protrusion 224a blocks further rotation of the inner housing 220, the inner housing 220 may be fixed in a predetermined position.

The bearing 500 is coupled to the rotor 300 at step S1210. The bearing 500 is press-fitted to the rotor 300, and the bearing 500 is fixed in a predetermined position owing to the radially extended portion 340 in the rotor 300. Then, the rotor 300 to which the bearing 500 is fitted is mounted to the environment sensor 2 at step S1220. Because the protruding height of the first retaining protrusion 42 is smaller than that of the second retaining protrusion 52, the rotor 300 may be easily mounted to the environment sensor 2 using the press-fitting method. The bearing 500 fitted in the rotor 300 is fixed by the second retaining protrusion 52.

The outer housing 240 is mounted to the environment sensor 2 at step S1230. Particularly, the outer housing 240 may be coupled to the inner housing 220 mounted to the environment sensor 2. The entrance 242a of the coupling portion 242 is aligned with the assembly protrusion 226 and the outer housing 240 is rotated in a second direction (e.g., counterclockwise) to seat the assembly protrusion 226 in the seating portion 242b.

The hose 16 to which the connector 400 is mounted is inserted into the connecting portion 248 of the outer housing 240 at step S1240, thereby completing the assembly of the sensor cleaning device 100.

According to some embodiments of the present disclosure, the operation of the sensor cleaning system 1 is controlled as shown in FIG. 13.

At step S1300, control of the sensor cleaning system 1 starts. The controller 10 is configured to continuously monitor whether the environment sensor 2 is contaminated, at step S1310. Whether the environment sensor 2 is contaminated may be determined by a known method.

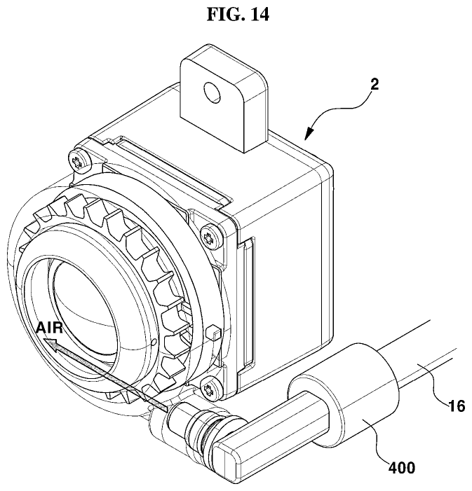

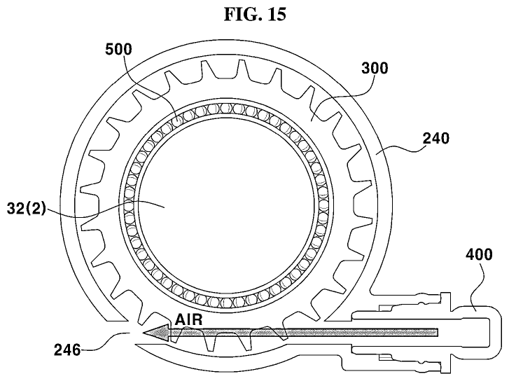

When contamination on the environment sensor 2 is not detected, the sensor cleaning system 1 stands by. When contamination on the environment sensor 2 is detected, the controller 10 of the sensor cleaning system 1 opens the valve 12, at step S1320. When the valve 12 is opened, compressed air is supplied to the environment sensor 2 via the hose 16, at step S1330. Referring additionally to FIGS. 14 to 15, when compressed air is supplied to the sensor cleaning device 100, the rotor 300 is rotated by the compressed air supplied into the outer housing 240. As the rotor 300 and the lens 320 of the rotor 300 rotate together, foreign substances present on the lens 320 may be removed by a centrifugal force. The compressed air supplied into the outer housing 240 may be discharged through the hole 246. The position and shape of the hole 246 may be changed to suit design conditions.

The sensor cleaning device according to the present disclosure may effectively clean the environment sensor. Moreover, the sensor cleaning device according to the present disclosure may protect the environment sensor and prevent damage thereof. Furthermore, the sensor cleaning device may be easily assembled and disassembled, making maintenance simple.

In addition, the sensor cleaning system according to the present disclosure may effectively clean the environment sensor.

As is apparent from the above description, the present disclosure provides the following effects.

According to the present disclosure, provided is a sensor cleaning device and system capable of effectively protecting an environment sensor and providing an excellent cleaning performance.

According to the present disclosure, provided is a vehicle including the sensor cleaning device and system.

Effects of the present disclosure are not limited to what has been described above, and other effects not mentioned herein should be clearly recognized by those having ordinary skill in the art based on the above description.

It should be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A sensor cleaning device, comprising:
a housing mounted to an environment sensor, wherein a compressed fluid is selectively supplied into the housing; and
a rotor disposed in the housing and configured to rotate with respect to the environment sensor by the compressed fluid.

2. The sensor cleaning device of claim 1, wherein the rotor comprises a lens, wherein the lens is disposed to overlap a sensing portion of the environment sensor.

3. The sensor cleaning device of claim 1, further comprising a bearing disposed between the rotor and the environment sensor.

4. The sensor cleaning device of claim 3, wherein:
a first portion of the bearing is supported by a wall formed in an inner side surface of the rotor, and
a second portion of the bearing is supported by a retaining protrusion formed on the environment sensor.

5. The sensor cleaning device of claim 4, wherein the retaining protrusion comprises:
a first retaining protrusion; and
a second retaining protrusion disposed closer to a central portion of the environment sensor than the first retaining protrusion,
wherein the first retaining protrusion has a protruding height smaller than a protruding height of the second retaining protrusion.

6. The sensor cleaning device of claim 1, wherein the housing comprises a connecting portion configured to supply the compressed fluid into the housing.

7. The sensor cleaning device of claim 6, further comprising a connector configured to allow fluid communication between a hose into which the compressed fluid is supplied and the connecting portion.

8. The sensor cleaning device of claim 1, wherein the housing comprises a hole configured to discharge the compressed fluid.

9. The sensor cleaning device of claim 1, wherein the housing comprises:
an inner housing detachably fixed to the environment sensor; and
an outer housing detachably coupled to the inner housing.

10. The sensor cleaning device of claim 9, further comprising a rib formed on the environment sensor,
wherein the inner housing comprises:
a groove into which the rib is insertable; and
a first fixation protrusion disposed adjacent to the groove and configured to contact with the rib when the inner housing is rotated.

11. The sensor cleaning device of claim 10, wherein the inner housing further comprises
a second fixation protrusion disposed adjacent to the first fixation protrusion and having a protruding height greater than a protruding height of the first fixation protrusion.

12. The sensor cleaning device of claim 9, wherein:
the inner housing comprises an assembly protrusion, and
the outer housing comprises a coupling portion connectable to the assembly protrusion.

13. The sensor cleaning device of claim 12, wherein the coupling portion comprises:
an entrance into which the assembly protrusion is inserted; and
a seating portion on which the assembly protrusion is seated, and
wherein the coupling portion extends in a circumferential direction of the outer housing from the entrance to the seating portion.

14. A vehicle comprising a sensor cleaning device,
wherein the sensor cleaning device comprises:
a housing mounted to an environment sensor, wherein a compressed fluid is selectively supplied into the housing; and
a rotor disposed in the housing and configured to rotate with respect to the environment sensor by the compressed fluid.

15. A sensor cleaning system, comprising:
a valve configured to supply compressed air and being openable;
a sensor cleaning device configured to be in fluid communication with the valve; and
a controller configured to control an operation of the valve,
wherein the sensor cleaning device comprises:
a housing mounted to an environment sensor of a vehicle, wherein the compressed air is supplied to the housing; and
a rotor disposed in the housing and configured to rotate by the compressed air.

16. The sensor cleaning system of claim 15, wherein the rotor comprises a lens disposed to overlap a sensing portion of the environment sensor.

17. A method of controlling a sensor cleaning system, the method comprising:
detecting, by a controller, contamination on an environment sensor of a vehicle;
opening, by the controller, a valve configured to supply compressed air in response to determining that the environment sensor is contaminated; and
rotating a sensor cleaning device using the compressed air supplied to the sensor cleaning device, wherein the sensor cleaning device is mounted to the environment sensor and is configured to be in fluid communication with the valve.

18. The method of claim 17, further comprising:
supplying the compressed air to a housing of the sensor cleaning device; and
providing a rotor in the housing to be rotatable with respect to the environment sensor.
